(19) United States
(12) Patent Application Publication
(10) Pub. No.: US 2019/0073928 A1
(43) Pub. Date: Mar. 7, 2019

(54) HEAT TRANSFER LABEL WITH MULTIPLE RESPONSIVE EFFECTS

(71) Applicant: Illinois Tool Works Inc., Glenview, IL (US)

(72) Inventors: Huanyu Wei, Wilbraham, MA (US); Caroline M. O'Leary, Cork (IE); Isaac Campos, Cork (IE)

(21) Appl. No.: 16/115,231

(22) Filed: Aug. 28, 2018

Related U.S. Application Data
(60) Provisional application No. 62/555,423, filed on Sep. 7, 2017.

(51) Int. Cl. G09F 3/00; B44C 1/17; B44F 1/10; G09F 3/04

(52) U.S. Cl. CPC G09F 3/0294; B44C 1/1716; B65C 5/04; B44F 1/10; G09F 3/04; B44C 1/172

(57) ABSTRACT

A multiple responsive effect heat transfer label includes a carrier, and first and second responsive effect design layers. The first responsive effect design layer is positioned on the carrier and the second responsive effect design layer is positioned on the first responsive effect design layer. The first responsive effect design layer is formulated from an ink that changes color when subjected to a first environmental stimulus and the second responsive effect design layer is formulated from an ink that changes color when subjected to a second environmental stimulus different from the first environmental stimulus. The color change of the first responsive design layer is independent of the color change of the second responsive design layer. The first responsive design layer is configured to separate from the carrier and the second responsive design layer separates with the first responsive design layer to define a multiple responsive effect feature adhered to a target object upon application of heat and pressure. A method of providing a durable, multiple responsive effect feature on a target object is also disclosed.

### CROSS-REFERENCE TO RELATED APPLICATION DATA

This application claims the benefit of and priority to Provisional U.S. Patent Application Ser. No. 62/555,423, filed Sep. 7, 2017, titled, HEAT TRANSFER LABEL WITH MULTIPLE RESPONSIVE EFFECTS.

### BACKGROUND

Heat transfer labels are well known and used in various industries. For example, heat transfer labels are used to transfer indicia onto commercial products, sports equipment, fabrics and other substrates. Typically, heat transfer labels include thermoplastic layers capable of being adhered to substrates upon application of heat and pressure.

Various types of heat transfer labels are known. Some labels are UV curing heat transfer labels and other are solvent-based or water-based thermoplastic ink systems. Examples of UV curing heat transfer labels are disclosed in Downs et al., U.S. Pat. No. 5,919,834, and Colella et al., U.S. Pat. No. 9,266,373, which documents are commonly assigned with the present application and are incorporated in their entirety by reference. Colella et al. discloses a textured heat transfer label.

Heat transfer labels with a textured feel (e.g. raised and/or recessed areas) are known, such as those disclosed in Colella, U.S. Pat. No. 9,349,305, as are metallized heat transfer labels, such as those disclosed in Colella, et al., U.S. Pat. No. 7,910,203. Also known are embossed heat transfer labels, such as those disclosed in O'Leary, et al., U.S. Pat. No. 9,675,996, which patent is also commonly assigned with the present application and is incorporated in its entirety by reference. These labels are produced by printing an embossing layer that may, for example, include a pattern, on a carrier and printing a design layer over the embossing layer. The design layer is then transferred onto the item to decorated. The design layer as transferred to the item has the embossed pattern therein.

Other labels are known that produce singular visual effects. For example, labels are known that produce thermochromic effects, such as those disclosed in Tsai, U.S. Pat. No. 7,906,189, label are known that produce photochromic effects, labels are known that produce phosphorescent effects and so on. However, in each of these labels, the effects are singular. That is, there is only one visual effect produced by any one label type when exposed to a certain environment or environmental stimulus.

Accordingly, there is a need for a label, and method of making such a label, that provides multiple responsive visual effects.

### BRIEF SUMMARY

A multiple responsive effect heat transfer label includes a carrier, and first and second responsive effect design layers. The first responsive effect design layer is positioned on the carrier and the second responsive effect design layer is positioned on the first responsive effect design layer. The first responsive effect design layer is formulated from an ink that changes color when subjected to a first environmental stimulus and the second responsive effect design layer is formulated from an ink that changes color when subjected to a second environmental stimulus different from the first environmental stimulus. The color change of the first responsive design layer is independent of the color change of the second responsive design layer. The first responsive design layer is configured to separate from the carrier and the second responsive design layer separates with the first responsive design layer to define a multiple responsive effect feature adhered to a target object upon application of heat and pressure.

In an embodiment, the label includes a carrier and a first responsive effect design layer on the carrier. The first responsive effect design layer is formulated from an ink that changes color when subjected to a first environmental stimulus. A second responsive effect design layer is positioned on the first responsive effect design layer. The second responsive effect design layer is formulated from an ink that changes color when subjected to a second environmental stimulus different from the first environmental stimulus. The color change of the first responsive design layer is independent of the color change of the second responsive design layer.

The first responsive design layer is configured to separate from the carrier, the second responsive design layer separating with the first responsive design layer to define a multiple responsive effect feature adhered to a target object upon application of heat and pressure.

In some embodiments, the label includes a backing layer positioned on the first responsive effect layer, opposite the carrier. The label can also include a backing layer positioned on the second responsive effect layer, opposite first responsive effect design layer. The backing layer can be a clear ink.

In an embodiment, the label includes a release layer positioned on the carrier, between the carrier and the first responsive effect design layer.

In embodiments, the first and/or second responsive effect design layer is formulated from a responsive effect ink including a resin dispersion and a responsive effect pigment. The resin can be solvent based or water based resin dispersion or a 100 percent solid resin or a UV/LED curable resin.

The first environmental stimulus can be one of heat, ultraviolet energy, direct light and reflective light and the second environmental stimulus is a different one of heat, ultraviolet energy, direct light and reflective light. The first and/or second responsive effect design layer can be formulated from a responsive effect ink that is solvent based or water based or a 100 percent solid resin or a UV/LED curable.

In an embodiment, a multiple responsive effect heat transfer label includes a carrier, and a first responsive effect design layer on the carrier, the first responsive effect design layer formulated from an ink that changes from a first color to a second color when subjected to a first environmental stimulus and a second responsive effect design layer on the first responsive effect design layer, the second responsive effect design layer formulated from an ink that changes from a third color to a fourth color when subjected to a second environmental stimulus different from the first environmental stimulus. The color change of the first responsive design layer is independent of the color change of the second responsive design layer and the first responsive design layer is configured to separate from the carrier, the second responsive design layer separating with the first responsive design layer defining a multiple responsive effect feature adhered to a target object upon application of heat and pressure.

In an embodiment, the first color, the second color, the third color and the fourth color are different from one another. In an embodiment, the first color and one of the third color or the fourth color are the same. In an embodiment, the second color and one of the third color and the fourth color are the same. That is, although the colors of the first responsive design layer are different and the colors of the second responsive design layer are different, one of the colors of the first responsive design layer may be the same as one of the colors of the second responsive design layer.

A method of providing a durable, multiple responsive effect feature on a target object includes the steps of providing a multiple responsive effect heat transfer label having a carrier, a first responsive effect design layer on the carrier, the first responsive effect design layer formulated from an ink that changes color when subjected to a first environmental stimulus, and a second responsive effect design layer on the first responsive effect design layer, the second responsive effect design layer formulated from an ink that changes color when subjected to a second environmental stimulus different from the first environmental stimulus, wherein the color change of the first responsive design layer is independent of the color change of the second responsive design layer.

The method can further include placing the multiple responsive effect heat transfer label onto the object with the second responsive effect design layer closer to the target object than the carrier is closer to the object, applying heat and pressure to a back side of the carrier and separating the first responsive effect design layer from the carrier to define the multiple responsive effect feature and transferring and adhering the multiple responsive effect feature to the target object.

Such a method produces a multiple responsive effect feature in which the first responsive effect feature exhibits a first color when subjected to a first environmental stimulus and a second color upon a change in the first environmental stimulus and the second responsive effect feature exhibits a first color when subjected to a second environmental stimulus different from the first environmental stimulus and a second color upon a change in the second environmental stimulus.

In a method, the first environmental stimulus is one of heat, ultraviolet energy, direct light and reflective light illumination and wherein the second environmental stimulus is a different one of heat, ultraviolet energy, direct light and reflective light illumination.

Other aspects, objectives and advantages will become more apparent from the following detailed description when taken in conjunction with the accompanying drawings.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a schematic cross sectional view of an embodiment of a multiple responsive effect heat transfer label according to an embodiment;

FIG. 2 is a schematic cross sectional view of the multiple responsive effect heat transfer label of FIG. 1 applied to a target object;

FIG. 3 is an overhead or plan view of an example of the multiple responsive effect heat transfer label of FIGS. 1 and 2 applied to a target object;

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

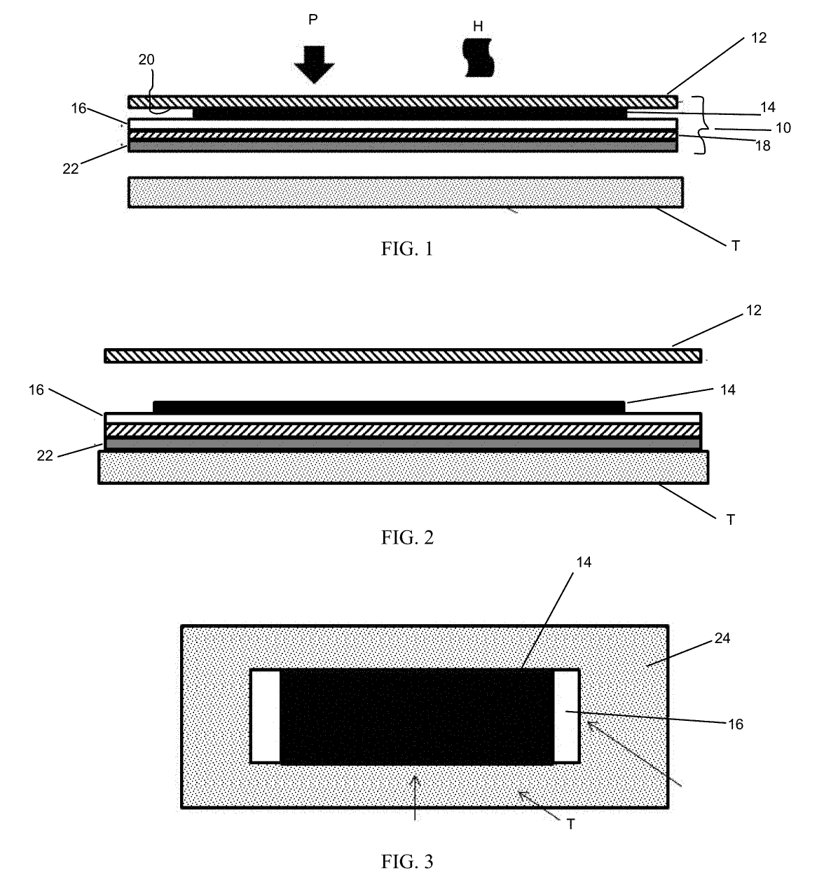

Referring now to the figures, FIG. 1 shows a schematic cross sectional view of an embodiment of a multiple responsive effect heat transfer label 10. Layer thicknesses are exaggerated for easy understanding and are not proportional in this embodiment and other embodiments shown in other figures in this disclosure. The multiple responsive effect heat transfer label 10 generally includes a carrier 12, such as a carrier web, two or more responsive effect design layers 14, 16 and an optional backing layer 18. The label 10 can also optionally include one or both of a release layer or release coating 20 and an adhesive layer 22. FIGS. 2 and 3 illustrate the multiple responsive effect heat transfer label 10 as applied to a target object T in cross-sectional view (FIG. 2), and in plan view (FIG. 3). For purposes of the present disclosure, the responsive effect design or layers 14, 16 will be referred to in the singular (layer), but it is to be understood that more than one layer can be present on the label 10 as discussed in more detail below.

In some embodiments, one of the release layer 20 and the adhesive layer 22 is used, in some embodiments both the release layer 20 and the adhesive layer 22 are used and in some embodiment neither the release layer nor the adhesive layer are used. In embodiments in which the release layer 20 is used, the release layer typically, but not always, extends over the entirety of the carrier 12. Likewise, in embodiments in which an adhesive layer 22 is used, the adhesive layer typically, but not always, extends over the entirety of the portion of the label 10 to be transferred to a target object T.

The multiple responsive effect heat transfer label is configured such that the adhesive layer and the responsive effects design layers transfer and adhere to the target object, upon application of heat H and pressure P on an outer surface of the carrier. When applied on the target object, the responsive effect design layers 14, 16 provide differing features that have one appearance when viewed when subjected to one environment or environmental stimulus and a second, different appearance when viewed when subjected to a different environment or environmental stimulus. For purposes of the present disclosure, reference to subjecting the label to environment(s) and environmental stimulus or stimuli means subjecting the label to environments and stimuli such as heat (thermochromic), UV energy (photochromic), direct light (photoluminescence—phosphorescence, fluorescence), reflected light (reflective) and the like.

For example a label that has combined thermochromic and photochromic design layers will exhibit one visual effect when subjected to heat (the thermochromic effect) and a different visual effect when subjected to ultraviolet light/radiation (photochromic effect). However, it will be understood that such a label can exhibit four visual effects due to the combination of the responsive effect design layers. In the example above, if the thermochromic conversion temperature is 29° C. and the thermochromic design layer is red below 29° C. and colorless above 29° C., and the photochromic conversion occurs when the photochromic design layer is subjected to sunlight and the photochromic design layer is light yellow when indoors (not subjected to UV light from the sun) and blue when subjected to UV light, then there are four possible combinations of effects: (1) a red/light yellow combination effect when below 29° C. and indoors; (2) a red/blue combination effect when below 29° C. and in sunlight; (3) a colorless/light yellow combination effect when above 29° C. and indoors; and (4) a blue/blue combination effect when above 29° C. and in sunlight. It will also be appreciated that reference to color includes a lack of color or a colorless visual effect.

In embodiments, a first responsive effect design layer is printed directly onto the carrier. Optionally, a release layer can be applied to the carrier before printing the first responsive effect design layer. And, optionally, a first backing layer can be applied to the first responsive effect design layer. A second responsive effect design layer is then printed onto the first responsive effect design layer (or onto the first backing layer if used). An adhesive layer, if needed, is then applied or printed over the top most layer (which may be a responsive effect design layer or a backing layer). It will also be appreciated that the two or more responsive effect design layers can include logos, designs, and the like.

The carrier can be formed from a wide variety of materials as will be recognized by those skilled in the art. One suitable material for the carrier is a untreated packaging grade polyester film, such as a 92 gauge (92 ga) clear, untreated packaging grade polyester film. Other suitable materials include polyethylene phthalate (PET) and polypropylene (PP). As will be readily appreciated, one benefit of using a clear material for carrier is that, if desired, one can inspect the quality of the subsequent layers of the label by looking at the layers through the carrier.

The material for the carrier is selected such that surface energy of the carrier is sufficiently high for printing the responsive effect design layer or the release layer, if used, and to allow the release layer if used to remain bonded to the carrier after the responsive effect design layers, backing layer(s) and the adhesive layer, if used, are transferred to the target object upon application of heat and pressure.

The release layer, if used, is printed on the carrier. As shown in FIG. 1, the release layer can be printed on a larger area than the responsive effect design layers and the backing layer. The release layer is provided between the carrier and the first responsive effect design layer. The first responsive effect design layer has a lower affinity for the carrier or release layer, if used, than for the backing layer. The release layer, if used, is provided to facilitate a clean separation of the first responsive effect design layer, from the rest of the carrier upon application of heat and pressure. When a release layer is used, it prevents the first responsive effect design layer from bonding to the carrier upon application of heat pressure, and thus permits transfer of the responsive effect design layers (and the backing layer(s) if used) to the target object.

In one embodiment, the release layer may be formed from a wax comprising thermoplastic polyamide resin having a softening point below the label application temperature. In such an embodiment, the release layer softens at application and becomes an anti-blocking layer, which allows the color design layer and the adhesive layer, if used, to release and transfer to the target object.

The optional backing layer or layers are used to provide contrast for the responsive effect design layers. As noted above, the backing layer, if used, is applied over the responsive effect design layer(s) and can provide a backing or contrast to the responsive effect design layers) and/or to provide contrast between the responsive effect design layer(s) themselves and/or to provide contrast between the responsive effect design layer(s) and the target object. The backing layer can be any of a wide variety of inks, including, for example, water or solvent based inks, 100 percent solid resin, UV/LED curable inks and the like. In one example, the UV/LED curable ink can be prepared by dissolving a thermoplastic resin in a monomer, an oligomer, or a monomer/oligomer mixture, and incorporating into a finished photoinitiated ink system. It should be understood that any monomer, oligomer, or monomer/oligomer mixture which can dissolve the thermoplastic resin component and remain compatible with the other components of the labels are acceptable. Suitable monomers for dissolving the thermoplastic resin component include esters of acrylic acid and methacrylic acid such as lauryl acrylate, isobornyl acrylate, 2-phenoxyethyl acrylate, glycidyl methacrylate, tetraethoxylated nonylphenol acrylate, and propoxylated neopentyl glycol diacrylate.

Thermoplastic resins suitable for the UV/LED curable ink include epoxies, polyurethanes, polymethacrylates, polyethylene vinyl acetates, polyvinyl chlorides, vinyl chloride/vinyl acetate copolymers, functionalized vinyl chloride/vinyl acetate copolymers, chlorinated halogenated polyolefins such as chlorinated and fluorinated polyolefins, and polystyrene.

Suitable photocurable monomer initiators include benzophenone, alpha ketone, thiophenyl morpholinopropanone (Irgacure® 907), morpholinophenylaminohexanone (Irgacure® 369), cyclohexylphenyl ketone (Irgacure® 184), hydroxyphenylpropanone (Darocur® 1173), and isopropylthioxanthone (Darocur® ITX), alkylated benzophenone (Esacure® TZT), diphenyl (2,4,6-trimethylbenzoyl) phosphine oxide (Genocure TPO), and poly 4-(2-hydroxy-2-methylpropionyl) alpha-methyl styrene (Escacure® KIP-100F). Irgacure® 907, 369, 184, Darocur® 1173, and Darocur® ITX are products available from BASF. Genocure TPO is a product of RAHN. Generally, suitable initiators are those which produce free radicals upon exposure to UV/LED radiation.

The adhesive layer, if used, is applied over the second or last responsive effect design color layer or the second or last backing layer if used. The adhesive layer may be formed from a thermoplastic composition that melts or softens upon application of heat and pressure, and adheres to the target object to attach the color shifting label feature to the target object. For example, suitable thermoplastic compositions may be formulated with thermoplastic resins and hotmelt powders. Suitable hotmelt powder resins include, but are not limited to, thermoplastic polyurethanes, copolyesters, and copolyamides. In such a thermoplastic composition, the hotmelt powder may be dispersed in thermoplastic resin binder and may have a particle size distribution suitable for the screen mesh being used for printing.

As will be appreciated from the above disclosure and the figures, the responsive effect design layers are printed on the carrier or the release layer if used. Formulation of the inks for the responsive effect design layers are provided below. The responsive effect design layers are configured and formulated so that the layer in contact with the carrier or release layer separate from the carrier and/or the release layer, and the layers cleanly transfer to the target object and retain their respective responsive effects or characteristics. As noted above, the responsive effects design layer inks have a lower affinity for the carrier (and its release layer if present) than for the target object or the adhesive layer if one is used in the construction, in order to facilitate clean transfer to the target object when heat and pressure are applied to the back side of the carrier.

In one embodiment, the responsive effect design layer is prepared as a clear ink into which a responsive effect design additive (which will be referred to herein as the design additive) is added to formulate a responsive effect ink. The responsive effect additive can include a pigment and a resin. The responsive effect design layer can be a solvent based or a water based, a 100 percent solid resin, or a UV/LED curable ink. One solvent based clear ink composition includes the following components:

| Component | % by weight of the clear ink |
|---|---|
| NA 2146 | 90.33 |
| Demosphenon C1200 | 2.48 |
| (Ethyl 3-Ethoxypropionate) (EEP | 6.78 |
| solvent) | |
| Foamex N (defoamer) | 0.41 |
| Total | 100.00 |

A first formulation, one that can be used for example, in an apparel application, combines thermochromic (heat) and photochromic (UV reactive) effects, so that when the temperature is below 29° C., the first responsive design layer (the thermochromic design layer) is red and when the temperature is above 29° C., the first responsive design layer is colorless, and when there is no sunlight/UV light such as when indoors, the second responsive design layer (the photochromic design layer) is light yellow and when subjected to sunlight/UV light such as when outdoors, the second responsive design layer turns into a blue color. In this formulation, there are four potential different appearances/looks in this design depending on temperature and UV light, including: (1) a red/light yellow combination effect when below 29° C. and indoors; (2) a red/blue combination effect when below 29° C. and in sunlight; (3) a colorless/light yellow combination effect when above 29° C. and indoors; and (4) a blue/blue combination effect when above 29° C. and in sunlight.

To create this effect, a first (thermochromic) responsive effect ink was formulated by adding 200 grams (g) of a pigment, BPA free thermochromic 29° C. Red Pigment, commercially available from New Color Chemical Co., Limited and 50 g of an isocyanate crosslinker, such as DESMODUR®N75, commercially available from Bayer MaterialScience AG of Germany, into 800 g of the clear ink formulation above, adding the design additive while mixing. The second (photochromic) responsive effect ink was formulated by adding 200 grams (g) of a pigment, BPA free photochromic Blue Pigment, commercially available from New Color Chemical Co., Limited and 50 g of an isocyanate crosslinker, such as DESMODUR®N75, commercially available from Bayer MaterialScience AG of Germany, into 800 g of the clear ink formulation above, adding the design additive while mixing.

To prepare the heat transfer label, the above thermochromic ink is printed on a carrier web—a PET film, such as a PET film, PolyStrip SLV (commercially available from Burkhardt/Freeman, Inc., of South Deerfield, Mass.) as the first (thermochromic) responsive design layer. A clear ink, such as 275142X (available from ITW Graphics of Manchester, Conn.) is printed on the thermochromic design layer. The above photochromic ink was then printed on the clear ink layer. A backup white ink, such as 9ES1020, which is a solvent based polyurethane white ink, was printed on the photochromic ink layer and an adhesive, 275140A (available from ITW Graphics of Manchester, Conn.), which is a solvent based thermoplastic polyurethane adhesive, was printed on the backup white ink layer to create a heat transfer label with both thermochromic and photochromic (UV reactive) effects.

The label was transferred to a fabric by applying the carrier with the label face down on the fabric in a flat-bed stamper (available from Insta Graphic Systems, of Cerritos, Calif.) at a temperature of 302° F. and a pressure of 60 psi for a 15 second dwell time.

The sample label as applied to a target object was tested for adhesion, abrasion resistance, visual appearance and color steadfastness, staining, durability and dye migration, as appropriate for the target object. The fabric with the multiple responsive effect heat transfer label was subject to a Nike standard embellishment durability wash tests, Accelerated Wash, 5 at 60° C. and Innovation Standard Wash, 15 washes at 60° C., with a Miele PW6065 washing machine and tumbled dry after each wash with an automatic dryer. The specimen fabric with the heat transferred multiple responsive effect feature passed the tests. No color change, no staining, no visual changes, and no adhesion failures were observed with the multiple effect feature.

The fabric with the multiple responsive effect heat transfer label was also subject to an AATCC standard crock test, 10 crocks with a SDLATLAS CM-5 AATCC crockmeter and TIC crockmeter 2″×2″ squares, and passed the test. No color transfer, abrasion or visual changes were observed.

Lacquer inks and dye blocker inks can also printed between the backing layer and the adhesive layer, to provide resistance to dye migration from the fabric, especially polyester fabrics. Again, the fabric with the thermochromic and photochromic (UV reactive) label with was subject to a standard dye migration test, and passed the test. No dye/color was observed to pass onto the label surface.

A second formulation, one that can be used for example, in an apparel application, combines reflective and photochromic (UV reactive) effects, so that when subjected to normal, room lighting, the first responsive design layer (the reflective design layer) is gray in color and when subjected to strong (indoor lighting) light in a dark environment, the first responsive design layer is reflective, and when there is no sunlight/UV light such as when indoors, the second responsive design layer (the photochromic design layer) is pale white and when subjected to sunlight/UV light such as when outdoors, the second responsive design layer turns purple in color. In this formulation, there are four potential different appearances/looks in this design depending on light illumination and UV light, including: (1) a gray/pale white combination effect when there is no strong sunlight and indoors; (2) a gray/purple combination effect when there is no strong light illumination but under sunlight/UV light; (3) a strong light reflection/purple combination effect when there is strong light illumination and under UV light; and (4) a strong light reflection/pale white combination effect when there is strong light illumination in dark and no UV light.

To create this effect, a second (photochromic) responsive effect ink was formulated by adding 200 grams (g) of a pigment, BPA free photochromic Purple Pigment, commercially available from New Color Chemical Co, Limited and 50 g of an isocyanate crosslinker, such as DESMODUR®N75, commercially available from Bayer MaterialScience AG of Germany, into 800 g of the clear ink formulation above, adding the design additive while mixing.

A grey silicone release ink, such as TT10116-3, commercially available from ITW Graphics was then printed on a transparent, reflective film, such as GTF 0125, commercially available from HANSE Corp, with a design. There was no silicone release ink printed in a graphic design area. A clear ink, such as 275142X was printed on the silicon release ink layer. The photochromic ink was printed on the clear ink layer.

A backup silver ink, such as 1EC2005, commercially available from ITW Graphics, which is a solvent based polyurethane ink with silver pigments, was printed on the photochromic ink layer and an adhesive, such as 275140A, was printed on the backup silver ink layer to make a heat transfer label with both reflective and photochromic (UV reactive) effects.

The label was transferred to a fabric by applying the carrier with the label face down on the fabric in a flat stamper at a temperature of 302° F. and a pressure of 60 psi for a 15 second dwell time.

The sample label as applied to a target object was tested for adhesion, abrasion resistance, visual appearance and color steadfastness, staining, durability and dye migration, as appropriate for the target object. The fabric with the multiple responsive effect heat transfer label was subject to the Nike standard embellishment durability wash tests, as noted above and the AATCC standard crock test. No color change, no staining, no visual changes, and no adhesion failures were observed with the multiple effect feature, and no color transfer, abrasion or visual changes were observed.

Again, lacquer inks and dye blocker inks can also printed between the backing layer and the adhesive layer, to provide resistance to dye migration from the fabric, especially polyester fabrics. Again, the fabric with the reflective and photochromic (UV reactive) label with was subject to a standard dye migration test, and passed the test. No dye/color was observed to pass onto the label surface.

A third formulation, again one that can be used for example, in an apparel application, combines phosphorescent (glow in the dark) and photochromic (UV reactive) effects. In this formulation, there are three potential different appearances/looks in this design, so that when subjected to normal, room lighting, the first and second responsive design layers (the phosphorescent and photochromic design layers) are light yellow/pale white in color, when subjected sunlight/UV light such as when outdoors, the photochromic design layer turns magenta in color and when in the dark, after being subjected to strong indoor or sunlight/UV light, the phosphorescent design layer will glow blue in color.

To create this effect, a first (phosphorescent) responsive effect ink was formulated by adding 600 grams (g) of a phosphorescent pigment, LumiNova® B300M, commercially available from UMC Corp. and 50 g of an isocyanate crosslinker, such as DESMODUR®N75, into 400 g of the clear ink formulation above, adding the design additive while mixing.

A second (photochromic) responsive effect ink was formulated by adding 200 grams (g) of a pigment, BPA free photochromic Purple Pigment, commercially available from New Color Chemical Co, Limited and 50 g of an isocyanate crosslinker, such as DESMODUR®N75, commercially available from Bayer Material Science AG of Germany, into 800 g of the clear ink formulation above, adding the design additive while mixing.

To prepare the heat transfer label, the above phosphorescent ink is printed on a carrier web—a PET film, such as a PET film, PolyStrip SLV (commercially available from Burkhardt/Freeman, Inc., of South Deerfield, Mass.) as the first (phosphorescent) responsive design layer. A clear ink, such as 275142X is printed on the phosphorescent design layer.

A backup white ink, such as 9ES1020, was printed on the phosphorescent ink layer and an adhesive, such as 275140A, was printed on the backup white ink layer to create a heat transfer label with both phosphorescent (glow in the dark) and photochromic (UV reactive) effects.

The label was transferred to a fabric by applying the carrier with the label face down on the fabric in a flat stamper at a temperature of 302° F. and a pressure of 60 psi for a 15 second dwell time.

The sample label as applied to a target object was tested for adhesion, abrasion resistance, visual appearance and color steadfastness, staining, durability and dye migration, as appropriate for the target object. The fabric with the multiple responsive effect heat transfer label was subject to the Nike standard embellishment durability wash tests, as noted above and the AATCC standard crock test. No color change, no staining, no visual changes, and no adhesion failures were observed with the multiple effect feature, and no color transfer, abrasion or visual changes were observed.

Again, lacquer inks and dye blocker inks can also printed between the backing layer and the adhesive layer, to provide resistance to dye migration from the fabric, especially polyester fabrics. Again, the fabric with the phosphorescent (glow in the dark) and photochromic (UV reactive) label with was subject to a standard dye migration test, and passed the test. No dye/color was observed to pass onto the label surface.

A fourth formulation, again one that can be used for example, in an apparel application, combines thermochromic and photochromic (UV reactive) effects using water based inks. In this formulation, there are four potential different appearances/looks in this design, so that when the temperature is below 31° C., the first responsive design layer (the thermochromic design layer) is yellow in color and when the temperature is above 31° C., and when there is no sunlight/UV light such as when indoors, the second responsive design layer (the photochromic design layer) is pale white in color and when subjected to sunlight/UV light such as when outdoors, the second responsive design layer turns green in color. In this formulation, there are four potential different appearances/looks in this design depending on temperature and UV light, including: (1) a yellow/pale white combination effect when below 31° C. and indoors; (2) a yellow/green combination effect when below 31° C. and in sunlight; (3) a pale white/pale white combination effect when above 31° C. and indoors; and (4) a green/green combination effect when above 31° C. and in sunlight.

To create this effect, a first (thermochromic) responsive effect ink was formulated by adding 214 grams (g) of a thermochromic pigment, BPA free thermochromic 31° C. Yellow Pigment, commercially available from New Color Chemical Co. and 4 g of Surfynol PSA336, 80 g of water and 17 g of IFSCT, an aziridine crosslinker, commercially available from ITW Graphics, into 702 g of CM4481, a water based clear ink based on water based polyurethane dispersions, commercially available from ITW Graphics, while mixing.

A second (photochromic) responsive effect ink was formulated by adding 171 g of a pigment, BPA free photochromic Green Pigment, commercially available from NCC, 10 g of Bemicoll ST and 10 g of Bemicoll XC and 20 g of Bemifuse K, all commercially available from Schmits, 12 g of Byketol PC and 50 g of Aquacer 513, both commercially available from BYK, 53 g water and 17 g of IFSCT into 674 g of CM4481, a water based clear ink based on water based polyurethane dispersions, commercially available from ITW Graphics, while mixing.

To prepare the heat transfer label, the above thermochromic ink is printed on a carrier web—a PET film, such as a PET film, PolyStrip SLV and a clear water-based ink layer, such as CM4481 is printed on the thermochromic ink layer. The above photochromic ink is printed on the clear water-based ink layer.

A backup white ink, such as CM4491 which is a water based polyurethane white ink, commercially available from ITW Graphics is printed on top of the photochromic ink layer and an adhesive, such as CM4506, which is a water based thermoplastic polyurethane adhesive, commercially available from ITW Graphics, is printed on top of the backup white ink layer to make a heat transfer label with both thermochromic and photochromic (UV reactive) effects.

The label was transferred to a fabric by applying the carrier with the label face down on the fabric in a flat stamper at a temperature of 284° F. and a pressure of 60 psi for an 18 second dwell time.

The sample label as applied to a target object was tested for adhesion, abrasion resistance, visual appearance and color steadfastness, staining, durability and dye migration, as appropriate for the target object. The fabric with the multiple responsive effect heat transfer label was subject to the Nike standard embellishment durability wash tests, as noted above and the AATCC standard crock test. No color change, no staining, no visual changes, and no adhesion failures were observed with the multiple effect feature, and no color transfer, abrasion or visual changes were observed.

Again, lacquer inks and dye blocker inks can also printed between the backing layer and the adhesive layer, to provide resistance to dye migration from the fabric, especially polyester fabrics. Again, the fabric with the thermochromic and photochromic (UV reactive) label with was subject to a standard dye migration test, and passed the test. No dye/color was observed to pass onto the label surface.

A fifth formulation, again one that can be used for example, in an apparel application, combines phosphorescent and photochromic (UV reactive) effects using water based inks. In this formulation, there are three potential different appearances/looks in this design, so that when subjected to normal, room lighting, the first and second responsive design layers (the phosphorescent and photochromic design layers) are pale white in color, when subjected sunlight/UV light such as when outdoors, the photochromic design layer turns orange in color and when in the dark, after being subjected to strong indoor or sunlight/UV light, the phosphorescent design layer will glow green in color.

To create this effect, a first (phosphorescent) responsive effect ink was formulated by adding 600 g of a phosphorescent pigment, LumiNova® G300STM, 4 g of Surfynol PSA336, 50 g of water and 17 g of IFSCT, an aziridine crosslinker, into 346 g CM4481, a water based clear ink based on water based polyurethane dispersions, commercially available from ITW Graphics, while mixing.

The second (photochromic) responsive effect ink was formulated by adding 200 g of a pigment, BPA free photochromic BPA fee UV-PDF-2118 (Orange) Pigment, commercially available from UMC Corp., 4 g of Surfynol PSA336, 80 g of water, and 17 g of IFSCTN into 716 g of CM4481, while mixing.

To prepare the heat transfer label, the above phosphorescent ink is printed on a carrier web—a PET film, such as a PET film, PolyStrip SLV and a clear water-based ink layer, such as CM4481 is printed on the phosphorescent ink layer. The above photochromic ink is printed on the clear water-based ink layer.

A backup white ink, such as CM4491 is printed on top of the photochromic ink layer and an adhesive, such as CM4506 is printed on top of the backup white ink layer to make a heat transfer label with both phosphorescent and photochromic (UV reactive) effects.

The label was transferred to a fabric by applying the carrier with the label face down on the fabric in a flat stamper at a temperature of 284° F. and a pressure of 60 psi for an 18 second dwell time.

The sample label as applied to a target object was tested for adhesion, abrasion resistance, visual appearance and color steadfastness, staining, durability and dye migration, as appropriate for the target object. The fabric with the multiple responsive effect heat transfer label was subject to the Nike standard embellishment durability wash tests, as noted above and the AATCC standard crock test. No color change, no staining, no visual changes, and no adhesion failures were observed with the multiple effect feature, and no color transfer, abrasion or visual changes were observed.

Again, lacquer inks and dye blocker inks can also printed between the backing layer and the adhesive layer, to provide resistance to dye migration from the fabric, especially polyester fabrics. Again, the fabric with the phosphorescent and photochromic (UV reactive) label with was subject to a standard dye migration test, and passed the test. No dye/color was observed to pass onto the label surface.

Examples of other thermochromic pigments include, but are not limited to, thermochromic pigments from New Color Chemical, Co. Ltd. GWFR-01 (Red), GWFY-01 (Yellow), GWFB-03 (Blue), GWFG-04 (Green), GWFH-05 (Black), GWFV-06 (Violet), GWFDB-07 (Dark Blue), GWFTB-08 (Turkish Blue), GWFSB-09 (Sly Blue), GWFGG-10 (Grass Green), GWFO-11 (Orange), GWFM-12 (Magenta), GWFRR-13 (Rose Red), GWFVR-14 (Vermillion Red) and GWFC-15 (Brown); And BPA free versions of the above thermochromic pigments. Other suitable thermochromic pigments are available from New Prismatic Enterprises (NCC), distributed by United Mineral & Chemical Corporation (UMC), including two-phase color change, three-phase color change and multi-phase color change thermochromic pigments, such as, for example, 186C Red, 238C Rose Red, Rubine Red C Magenta, 497C Brown, 185C Vermilion, 021C Orange, 387C Yellow, Green C Charm Green, 335C Green, 313C Sky Blue, 320CTurkish Blue, 301U Blue, 294C Dark Blue, 2728C Violet and Black 5C2X Black, MC 31C C. Green-BF, 31C Orange—BF, and 31C T Blue-BF. BPA free versions of above thermochromic pigments are also available from United Mineral & Chemical Corporation (UMC), such as, TM-PDF-31C-3134 (Dark Blue), TM-PDF-31C-3131 (Blue) and TM-PDF-31C-3112C (Rose Red).

Examples of other photochromic (UV reactive) pigments include, but are not limited to, pigments commercially from New Color Chemical, Co. Ltd. including GGFR-01 (White Red), GGFY-02 (White Yellow), GGFB-03 (White Blue), GGFP-04 (White Purple), GGFSB-05 (White Sky Blue) and GGFO-06 (White Orange). And photochromic (UV reactive) pigments commercially available from New Prismatic Enterprises (NCC), such as, #12 Colorless to Purple, #13 Colorless to Sky Blue, #14 Colorless to Blue, #16 Colorless to Yellow, #17 Colorless to Peach Orange, #18 Colorless to Orange, #19 Colorless to Magenta and #22 Colorless to Gray. In addition, photochromic pigments (UV reactive) commercially available from United Mineral & Chemical Corporation (UMC) include BPA free UV-PDF-2119 (Magenta), BPA free UV-PDF-2118 (Orange), BPA free UV-PDF-2112 (Purple), BPA free UV-PDF-2113 (Sky Blue) and BPA free UV-PDF-2114 (Blue).

Examples of other phosphorescent (glow in dark) pigments include, but are not limited to, phosphorescent (glow in dark) pigments commercially available from New Prismatic Enterprises (NCC), distributed by United Mineral & Chemical Corporation (UMC), Yellow Green NL-YA, Blue NL-BA, Purple NL-PA and Red NL-RA, LumiNova®B-300M (#PBGVM-023), LumiNova®BG-300M (#PBM-060), LumiNova®V-300M (#PVM-050) and LumiNova®G-300STM, G-220STM, G-200STM, G-100STM, G300STC and G300STF. And, other suitable phosphorescent pigments such as fine crystals of zinc sulfide doped with copper, for example, those commercially available from United Mineral & Chemical Corporation (UMC), such as 6SSU Natural (Green emitting), GSR Natural (Yellow emitting), GSR 115/2 Orange (Orange emitting), GSS 205/1 Yellow, GSS 207/1 Orange-Yellow, GSS 305/1 Orange, GSS 507/1 Rose, GSS 905/1 Green, and GSS 8B/1 Blue.

Examples of suitable transparent reflective films include, but are not limited to, reflective film GTF M0125, transparent, commercially available from HANSE Corporation, LS001H transparent reflective film commercially available from SHENZHEN BLUEPORT REFLECTIVE MATERIAL Co. Ltd., and transparent reflective film commercially available from KUNSHAN WEIDING FILM TECHNOLOGY CO, LTD.

It is to be understood that the particular compositions of the carrier, the release layer, if used, the responsive effect design layers, and adhesive layer, if used, may vary from the specific compositions disclosed herein depending upon the composition of the target object T to which the label is to be applied and the desired matte finish.

It will also be appreciated that for the sake of simplicity of description, two responsive effect design layers and one or more backing layers and clear ink layers are disclosed, but that other layer configurations can be used to achieve a wide variety of desired visually appealing effects, all of which are within the scope and spirit of the present disclosure. Further, it will be understood that the backing layer(s) can be formulated to provide the adhesion needed to adhere the top most (relative to the carrier) layer to target object and that in some such applications, the adhesive layer may not be required.

It will also be appreciated that in a multiple responsive effect heat transfer label, the first responsive effect design layer can be formulated from an ink that changes from a first color to a second color when subjected to a first environmental stimulus and a second responsive effect design layer on the first responsive effect design layer, the second responsive effect design layer formulated from an ink that changes from a third color to a fourth color when subjected to a second environmental stimulus different from the first environmental stimulus.

And, in an embodiment, the first color, the second color, the third color and the fourth color are different from one another. In another embodiment, the first color and one of the third color or the fourth color are the same and in another embodiment, the second color and one of the third color and the fourth color are the same. That is, although the colors of the first responsive design layer are different from one another and the colors of the second responsive design layer are different from one another, one of the colors of the first responsive design layer may be the same as one of the colors of the second responsive design layer.

All percentages are percentages by weight unless otherwise noted.

The words “a” or “an” are to be taken to include both the singular and the plural. Conversely, any reference to plural items shall, where appropriate, include the singular. All patents and published application referred to in this disclosure are incorporated herein in their entirely whether or not expressly done so herein.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A multiple responsive effect heat transfer label, comprising:
a carrier; and
a first responsive effect design layer on the carrier, the first responsive effect design layer formulated from an ink that changes color when subjected to a first environmental stimulus; and
a second responsive effect design layer on the first responsive effect design layer, the second responsive effect design layer formulated from an ink that changes color when subjected to a second environmental stimulus different from the first environmental stimulus,
wherein the color change of the first responsive design layer is independent of the color change of the second responsive design layer, and
wherein the first responsive design layer is configured to separate from the carrier, the second responsive design layer separating with the first responsive design layer defining a multiple responsive effect feature adhered to a target object upon application of heat and pressure.

2. The label of claim 1, including a backing layer, the backing layer positioned on the first responsive effect layer, opposite the carrier.

3. The label of claim 1, including a backing layer, the backing layer positioned on the second responsive effect layer, opposite first responsive effect design layer.

4. The label of claim 1, including a release layer, the release layer positioned on the carrier, between the carrier and the first responsive effect design layer.

5. The label of claim 1, wherein the first and/or second responsive effect design layer is formulated from a responsive effect ink including a resin dispersion and a responsive effect pigment.

6. The label of claim 1, wherein the first environmental stimulus is one of heat, ultraviolet energy, direct light and reflective light and wherein the second environmental stimulus is a different one of heat, ultraviolet energy, direct light and reflective light illumination.

7. The label of claim 1, wherein the first and/or second responsive effect design layer is formulated from a responsive effect ink that is a solvent based ink, a water based ink, a 100 percent solid ink, or a UV/LED curable ink.

8. The label of claim 2 or 3, wherein the backing layer is a clear ink or a white ink or a silver ink.

9. The label of claim 9, wherein the ink is a water based ink, a solvent based ink, a 100 percent solid ink or a UV/LED curable ink.

10. The label of claim 5, wherein the resin is a water based resin, a solvent based resin, a 100 percent solid resin or a UV/LED curable resin.

11. A multiple responsive effect heat transfer label, comprising:
a carrier; and
a first responsive effect design layer on the carrier, the first responsive effect design layer formulated from an ink that changes from a first color to a second color when subjected to a first environmental stimulus; and
a second responsive effect design layer on the first responsive effect design layer, the second responsive effect design layer formulated from an ink that changes from a third color to a fourth color when subjected to a second environmental stimulus different from the first environmental stimulus,
wherein the color change of the first responsive design layer is independent of the color change of the second responsive design layer, and
wherein the first responsive design layer is configured to separate from the carrier, the second responsive design layer separating with the first responsive design layer defining a multiple responsive effect feature adhered to a target object upon application of heat and pressure.

12. The label of claim 11 wherein the first color, the second color, the third color and the fourth color are different from one another.

13. The label of claim 11 wherein the first color and one of the third color or the fourth color are the same.

14. The label of claim 11 wherein the second color and one of the third color and the fourth color are the same.

15. The label of claim 11, wherein the first environmental stimulus is one of heat, ultraviolet energy, direct light and reflective light illumination and wherein the second environmental stimulus is a different one of heat, ultraviolet energy, direct light and reflective light illumination.

16. A method of providing a durable, multiple responsive effect feature on a target object, comprising the steps of:
providing a multiple responsive effect heat transfer label having a carrier, a first responsive effect design layer on the carrier, the first responsive effect design layer formulated from an ink that changes color when subjected to a first environmental stimulus, and a second responsive effect design layer on the first responsive effect design layer, the second responsive effect design layer formulated from an ink that changes color when subjected to a second environmental stimulus different from the first environmental stimulus, wherein the color change of the first responsive design layer is independent of the color change of the second responsive design layer
placing the multiple responsive effect heat transfer label onto the object with the second responsive effect design layer closer to the target object than the carrier is closer to the object;
applying heat and pressure to a back side of the carrier; and
separating the first responsive effect design layer from the carrier to define the multiple responsive effect feature and transferring and adhering the multiple responsive effect feature to the target object,
wherein the first responsive effect feature exhibits a first color when subjected to a first environmental stimulus and a second color upon a change in the first environmental stimulus and the second responsive effect feature exhibits a first color when subjected to a second environmental stimulus different from the first environmental stimulus and a second color upon a change in the second environmental stimulus.

17. The method of claim 16, wherein the first environmental stimulus is one of heat, ultraviolet energy, direct light and reflective light illumination and wherein the second environmental stimulus is a different one of heat, ultraviolet energy, direct light and reflective light illumination.
